(19) United States
(12) Patent Application Publication
(10) Pub. No.: US 2026/0201168 A1
(43) Pub. Date: Jul. 16, 2026

(54) TYRES FOR VEHICLE WHEELS

(71) Applicant: Pirelli Tyre S.p.A., Milano (IT)

(72) Inventors: Luca GIANNINI, Milano (IT); Luciano TADIELLO, Milano (IT); Silvia GUERRA, Milano (IT); Luca ZOIA, Milano (IT); Federica FERRUTI, Milano (IT)

(73) Assignee: Pirelli Tyre S.p.A., Milano (IT)

(21) Appl. No.: 19/136,631

(22) PCT Filed: Dec. 12, 2023
(86) PCT No.: PCT/IB2023/062545

§ 371 Date: Jun. 6, 2025

(30) Foreign Application Priority Data
Dec. 13, 2022 (IT) 102022000025512

(51) Int. Cl. C08L 97/00; B60C 1/00; B60C 11/00; C08H 7/00; C08L 7/00; C08L 9/06

(52) U.S. Cl. CPC C08L 97/005; B60C 1/0016; B60C 11/0008; C08H 6/00; C08L 7/00; C08L 9/06; B60C 2011/0025; C08L 2205/03; C08L 2312/00

(57) ABSTRACT

The present invention relates to a tyre for vehicle wheels which comprises at least one structural element comprising a vulcanised elastomeric compound obtained by vulcanisation of a vulcanisable elastomeric composition comprising per 100 phr of diene elastomeric polymer: (i) a predispersion of a diene elastomeric polymer and lignin, in an amount to provide the elastomeric composition with 100 to 10 phr of diene elastomeric polymer an amount of lignin equal to or greater than 5 phr, (ii) 0 to 90 phr of at least one diene elastomeric polymer, (iii) 5 to 50 phr of a reinforcing filler, (iv) from 0.1 to 12 phr of at least one vulcanising agent, wherein said lignin is lignin functionalised with an acyl group represented by the following formulas (1) and (2): where R₁, R₂, R₃ and R₄ are as defined in the description.

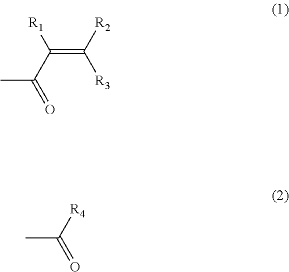

### FIELD OF THE INVENTION

The present invention relates to a tyre for vehicle wheels. More specifically, the present invention relates to a tyre comprising at least one structural element comprising a vulcanised elastomeric compound obtained by vulcanisation of a vulcanisable elastomeric composition comprising a predispersion of natural rubber and lignin functionalised with an acyl group comprising groups reactive with diene polymers in the vulcanisation step represented by the following formulas (1) and (2):

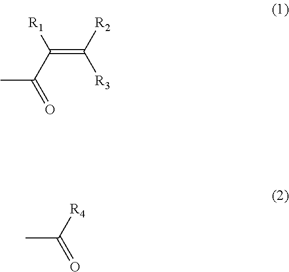

where R₁, R₂, R₃ and R₄ are as defined in the present description.

### PRIOR ART

A tyre for vehicle wheels typically comprises a carcass structure comprising at least one carcass layer having opposite lateral edges associated with respective bead structures, a belt structure applied in a radially external position to the carcass structure, and a tread band disposed in a position radially external to the belt structure.

The carcass structure is designed, in addition to supporting the weight of the vehicle, to resist the inflation pressure and all the lateral and longitudinal stresses to which the running tyre is subjected following contact with the road surface.

The belt structure is designed to transfer the aforementioned lateral and longitudinal stresses to the carcass structure and helps to confer the desired features of structural strength, grip, driving stability, controllability, directionality, road grip, comfort and to maintain these performances over time.

The bead structures are designed to withstand the circumferential, transverse and combined stresses that are transmitted between the wheel rim and the tyre during normal conditions of use, for example in acceleration, braking and when turning, possibly even at high speed.

The tread band is designed to ensure that the vehicle has correct road grip in all driving and weather conditions during the use of the tyre and for as long as possible.

In the production of the aforementioned tyre components, the use of elastomeric compositions comprising reinforcing fillers to improve the mechanical properties of the resulting vulcanised elastomeric compounds is known.

The most commonly used reinforcing fillers are carbon black and silica, alone or in combination with each other, but both have some negative aspects which the tyre industry has always been committed to reducing.

Carbon black gives the cross-linked products marked hysteretic features, i.e. an increase in heat dissipated in dynamic conditions (heat accumulation) which, in a tyre, may cause an increase in the rolling resistance of the tyre itself and, in particular in the internal structural elements of a tyre, operating temperatures that are too high. The increase in rolling resistance leads to an increase in fuel consumption by vehicles, resulting in higher costs of locomotion and air pollution. Operating temperatures that are too high may lead to a decrease in the mechanical properties of the elastomeric materials included in the semi-finished products and a possible degradation of the tyre.

Silica gives poor workability of non-cross-linked compositions, mainly due to excessive viscosity. Therefore, to obtain a good dispersion of the silica in the elastomeric polymer base, an intense and prolonged thermomechanical kneading of the composition is necessary. Furthermore, silica particles have a strong tendency to coalescence and form agglomerates even when finely dispersed in the elastomeric polymer base.

The Applicant has long perceived the need to supply more eco-sustainable and eco-compatible tyres and components thereof, for example, through the reduction or replacement of raw materials from petroleum with raw materials produced from renewable sources with the aim of maintaining and possibly improve, the performance of the tyre.

Among the most abundant biopolymers from renewable sources for application in tyres, starch, cellulose, lignin, and hemicellulose may be mentioned as examples. In the past, various attempts have been made to use some of these materials as reinforcing agents, which also have a lower specific weight than traditional reinforcing fillers. Lignin, for example, has been used, as it is or modified in various ways, as a reinforcing filler in tyre compounds.

Lignin is an organic polymer complex having a three-dimensional polymeric structure consisting of phenylpropane units, and belonging to the class of so-called phenylpropanoid compounds.

Lignins have very different compositions and molecular weights, both as a function of the biomass chosen and the process with which they are obtained. The composition varies both in terms of functional groups, mainly of the phenolic type, hydroxyl and carboxylic types, and in terms of molecular weight.

Vehicle wheel tyres comprising lignin are described in patent applications US2010/0204368, WO2009/145784, JP2008/308615, JP2010/242023, JP2010/248282, JP2014/129509, CN102718995, CN103756060, WO2014/097108, WO2017/109672, WO2022/144759, IT102021000029213, and IT102021000029831, and in patents GB723751, GB836393, US2610954, US2802815, US2906718, US3079360, US3163614, US3282871, US3296158, US3312643, US3364158, US3817974, US3984362 and US3991022.

### SUMMARY OF THE INVENTION

The Applicant has carried out an intense research activity in order to find the way to use lignin for the production of tyre compounds which has led to the filing of the international patent applications published with the number WO2017/109672 and WO2022/144759.

WO2017/109672 relates to a tyre for vehicle wheels comprising at least one structural element comprising a cross-linked elastomeric material obtained by vulcanising an elastomeric composition comprising a predispersion of natural rubber and lignin obtained by co-precipitation from natural rubber latex.

WO2022/144759 relates to a tyre for vehicle wheels comprising at least one structural element comprising a cross-linked elastomeric material obtained by vulcanisation of an elastomeric composition comprising a predispersion of natural rubber and lignin obtained by co-drying from natural rubber latex.

The Applicant has found that it is possible to create vulcanisable elastomeric compositions with further improved mechanical and hysteresis properties using the aforementioned predispersions in which a lignin functionalised with an acyl group comprising groups reactive with the diene polymers in the vulcanisation step is used, such as for example acrylate or methacrylate or polysulphide groups.

Reduced hysteresis values, particularly in the case of external structural elements such as the tread band, reduce heat dissipation due to the rolling of the tyre during road use, and consequently lead to reduced rolling resistance and lower fuel consumption. The reduction of hysteresis values, in particular in the case of internal structural elements of a tyre, such as for example the carcass structure, the belt structure and the bead components, also prevents the onset of excessively high operating temperatures within the structural components, which may risk compromising the integrity of the tyre.

The improvement of the mechanical properties, in particular in the external structural elements of a tyre, such as for example the tread band and the sidewalls, improves the resistance to mechanical stresses deriving from the rolling or sliding of the tyre during use, reducing tread wear and the risk of tearing of the sidewall and the blocks made on the tread surface, resulting in longer tyre life.

Therefore, in a first aspect thereof, the present invention relates to a tyre for vehicle wheels which comprises at least one structural element comprising a vulcanised elastomeric compound obtained by vulcanisation of a vulcanisable elastomeric composition comprising per 100 phr of diene elastomeric polymer:
(i) a predispersion of a diene elastomeric polymer and lignin, in an amount to provide the elastomeric composition with 100 to 10 phr of diene elastomeric polymer an amount of lignin equal to or greater than 5 phr,
(ii) 0 to 90 phr of at least one diene elastomeric polymer,
(iii) 5 to 50 phr of a reinforcing filler,
(iv) from 0.1 to 12 phr of at least one vulcanising agent,
wherein said lignin is lignin functionalised with an acyl group represented by the following formulas (1) and (2):

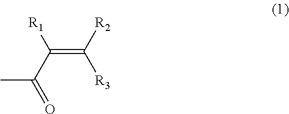

where R₁, R₂ and R₃, each independently, represents either a hydrogen atom, or a linear or branched C₁-C₆ alkyl or C₂-C₆ alkenyl group, optionally substituted by a carboxyl group (—COOH), or together they form a furan group substituted by a carboxyl group (—COOH),

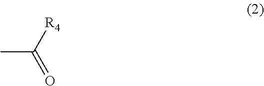

where R₄ represents a C₁-C₁₀ alkyl, C₇-C₁₅ alkylaryl, C₄-C₁₂ alkylcycloalkyl, or C₂-C₁₀ alkenyl group, linear or branched, substituted by or comprising a polysulfide —(S)ₙ—, where n is an integer from 2 to 4, and optionally substituted by a carboxyl group (—COOH), a hydroxy group (—OH), or a C₁-C₃ alkoxy group.

In a second aspect thereof, the present invention relates to a vulcanisable elastomeric composition comprising per 100 phr of diene elastomeric polymer:
(i) a predispersion of a diene elastomeric polymer and lignin, in an amount to provide the elastomeric composition with 100 to 10 phr of diene elastomeric polymer an amount of lignin equal to or greater than 5 phr,
(ii) 0 to 90 phr of at least one diene elastomeric polymer,
(iii) 5 to 50 phr of a reinforcing filler,
(iv) from 0.1 to 12 phr of at least one vulcanising agent,
wherein said lignin is lignin functionalised with an acyl group represented by the following formulas (1) and (2):

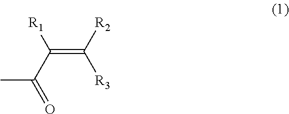

where R₁, R₂ and R₃, each independently, represents either a hydrogen atom, or a linear or branched C₁-C₆ alkyl or C₂-C₆ alkenyl group, optionally substituted by a carboxyl group (—COOH), or together they form a furan group substituted by a carboxyl group (—COOH),

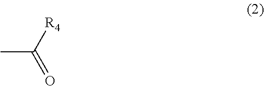

where R₄ represents a C₁-C₁₀ alkyl, C₇-C₁₅ alkylaryl, C₄-C₁₂ alkylcycloalkyl, or C₂-C₁₀ alkenyl group, linear or branched, substituted by or comprising a polysulfide —(S)ₙ—, where n is an integer from 2 to 4, and optionally substituted by a carboxyl group (—COOH), a hydroxy group (—OH), or a C₁-C₃ alkoxy group.

In a third aspect thereof, the present invention relates to a process for the mechano-chemical preparation of lignin functionalised with an acyl group comprising:
(a) feeding a mixing apparatus with lignin and a basic catalyst selected from the group consisting of alkali metal hydroxides or carbonates;
(b) mixing said lignin and said basic catalyst in said mixing apparatus;
(c) adding to the mixture of step (b) an acyl donor represented by an enolic ester of said acyl group, and mixing until completing the transesterification reaction;
(d) recovering said lignin functionalised with said acyl group,
where said acyl group is represented by the following formulas (1) and (2):

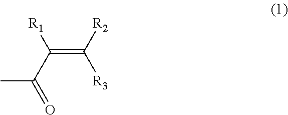

where R₁, R₂ and R₃, each independently, represents either a hydrogen atom, or a linear or branched C₁-C₆ alkyl or C₂-C₆ alkenyl group, optionally substituted by a carboxyl group (—COOH), or together they form a furan group substituted by a carboxyl group (—COOH),

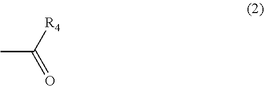

where R₄ represents a C₁-C₁₀ alkyl, C₇-C₁₅ alkylaryl, C₄-C₁₂ alkylcycloalkyl, or C₂-C₁₀ alkenyl group, linear or branched, substituted by or comprising a polysulfide —(S)ₙ—, where n is an integer from 2 to 4, and optionally substituted by a carboxyl group (—COOH), a hydroxy group (—OH), or a C₁-C₃ alkoxy group.

### Definitions

The term “elastomeric composition” means a composition comprising at least one diene elastomeric polymer and one or more additives, which by mixing and possible heating provides an elastomeric compound suitable for use in tyres and components thereof.

The components of the elastomeric composition are not generally introduced simultaneously into the mixer but typically added in sequence. In particular, the vulcanisation additives, such as the vulcanising agent and optionally the accelerant and retardant agents, are usually added in a downstream step with respect to the incorporation and processing of all the other components.

In the vulcanisable elastomeric compound, the individual components of the elastomeric composition may be altered or no longer individually traceable as modified, completely or in part, due to the interaction with the other components, of heat and/or mechanical processing. The term “elastomeric composition” herein is meant to include the set of all the components that are used in the preparation of the elastomeric compound, regardless of whether they are actually present simultaneously, are introduced sequentially or are then traceable in the elastomeric compound or in the final tyre.

The term “elastomeric polymer” indicates a natural or synthetic polymer which, after vulcanisation, may be stretched repeatedly at room temperature to at least twice its original length and after removal of the tensile load substantially immediately returns with force to approximately its original length (according to the definitions of the ASTM D1566-11 Standard terminology relating to Rubber).

The term “diene elastomeric polymer” indicates a polymer or copolymer derived from the polymerisation of one or more different monomers, among which at least one of them is a conjugated diene (conjugated diolefin).

The term “elastomeric compound” indicates the compound obtainable by mixing and optionally heating at least one elastomeric polymer with at least one of the additives commonly used in the preparation of tyre compounds.

The term “vulcanisable elastomeric compound” indicates the elastomeric compound ready for vulcanisation, obtainable by incorporation into an elastomeric compound of all the additives, including those of vulcanisation.

The term “vulcanised elastomeric compound” means the material obtainable by vulcanisation of a vulcanisable elastomeric compound.

The term “green” indicates a material, a compound, a composition, a component or a tyre not yet vulcanised.

The term “vulcanisation” refers to the cross-linking reaction in a natural or synthetic rubber induced by a typically sulphur-based or peroxide-based cross-linking agent.

The term “vulcanising agent” indicates a product capable of transforming natural or synthetic rubber into elastic and resistant material due to the formation of a three-dimensional network of inter- and intra-molecular bonds. Typical vulcanising agents are sulphur-based compounds such as elemental sulphur, sulphur, sulphur-donor agents as polymeric such bis [(trialkoxysilyl) propyl]polysulphides, thiurams, dithiodimorpholines and caprolactam-disulphide and/or peroxide such as dicumyl peroxide (DCP) and 2,5-dimethyl-2,5-di(tert-butylperoxy) hexane (DBPH).

The term “vulcanisation accelerant” means a compound capable of decreasing the duration of the vulcanisation process and/or the operating temperature, such as sulphenamides, thiazoles, dithiophosphates, dithiocarbamates, guanidines, as well as sulphur donors such as thiurams.

The term “vulcanisation activating agent” indicates a product capable of further facilitating the vulcanisation, making it happen in shorter times and possibly at lower temperatures. An example of activating agent is the stearic acid-zinc oxide system.

The term “vulcanisation retardant” indicates a product capable of delaying the onset of the vulcanisation reaction and/or suppressing undesired secondary reactions, for example N-(cyclohexylthio) phthalimide (CTP).

The term “vulcanisation package” is meant to indicate the vulcanising agent and one or more vulcanisation additives selected from among vulcanisation activating agents, vulcanisation accelerants and vulcanisation retardants.

The term “reinforcing filler” is meant to refer to a reinforcing material typically used in the sector to improve the mechanical properties of tyre rubbers, preferably selected from among carbon black, conventional silica, such as silica from sand precipitated with strong acids, preferably amorphous, diatomaceous earth, calcium carbonate, titanium dioxide, talc, alumina, aluminosilicates, kaolin, silicate fibres and mixtures thereof.

The term “mixing step (1)” indicates the step of the preparation process of the elastomeric compound in which one or more additives may be incorporated by mixing and optionally heating, except for the vulcanising agent which is fed in step (2). The mixing step (1) is also referred to as “non-productive step”. In the preparation of a compound there may be several “non-productive” mixing steps which may be indicated with 1a, 1b, etc.

The term “mixing step (2)” indicates the next step of the preparation process of the elastomeric compound in which the vulcanising agent and, optionally, the other additives of the vulcanisation package are introduced into the elastomeric compound obtained from step (1), and mixed in the material, at controlled temperature, generally at a compound temperature lower than 120° C., so as to provide the vulcanisable elastomeric compound. The mixing step (2) is also referred to as “productive step”.

The term “structural element” of a tyre refers to any elastomeric material component of the tyre. A structural element of a tyre may be the carcass structure, the belt structure, the tread, the sidewalls, the bead structure, the tread base, and so on.

The terms “radial” and “axial” and the expressions “radially internal/external” and “axially internal/external” are used referring respectively to a direction substantially parallel to the equatorial plane of the tyre and to a direction substantially perpendicular to the equatorial plane of the tyre, i.e. respectively to a direction substantially perpendicular to the axis of rotation of the tyre and to a direction substantially parallel to the axis of rotation of the tyre.

The terms “circumferential” and “circumferentially” are used with reference to the direction of the annular extension of the tyre, i.e. to the rolling direction of the tyre, which corresponds to a direction lying on a plane coinciding with or substantially parallel to the equatorial plane of the tyre.

By “substantially axial direction” it is meant a direction inclined, with respect to the equatorial plane of the tyre, by an angle of between about 70° and about 90°.

By “substantially circumferential direction” it is meant a direction stretched, with respect to the equatorial plane of the tyre, at an angle of between about 0° and about 10°.

For the purposes of the present description and the following claims, the term “phr” (acronym for parts per hundreds of rubber) indicates the parts by weight of a given elastomeric compound component per 100 parts by weight of the elastomeric polymer, considered net of any extension oils.

Unless otherwise indicated, all the percentages are expressed as percentages by weight.

### Functionalised Lignin

Natural lignin is a biopolymer synthesised in the plant world and second in amount produced only to cellulose. Biomass formed between cellulose and lignin represents approximately 70% of total biomass. Lignin is a heavy and complex organic polymer consisting mainly of phenolic compounds. In particular, lignin is composed of a cross-linked and three-dimensional polymer structure of phenylpropane units, above all phenylpropyl alcohols (coumaryl, coniferyl and sinapyl). Alcohols are synthesised by plants by reduction of the corresponding acids by the enzyme cinnamyl-CoA-NADPH oxidoreductase.

The components of the lignin are present in different quantities depending on the type of plant in which it forms. Coniferyl alcohol is the most abundant precursor of conifer lignin. The lignin of woody (broad-leaved) angiosperms derives mainly from sinapyl alcohol. In the composition of the lignin of herbaceous plants, mainly grasses, p-coumaryl, coniferyl and sinapyl alcohols are all present in comparable quantities.

The polymeric structure of lignin is very complex and develops in a three-dimensional way with the formation of cross-links that include ether bonds (C—O—C), carbon bonds (C—C), and ester bonds (CO—O—C) between the different phenylpropane units.

The main source of lignin comes from the paper production industry and the bio-fuel production industry. In both cases, lignin represents a by-product which has to be separated from the main product, cellulose or bio-ethanol. The raw unpurified lignin obtained from the separation process is normally burnt to produce energy. The process used to separate the lignin from the other plant components (celluloses and hemicelluloses) produces different types of lignin.

In the industry, two main types of raw lignin are distinguished: sulphured lignin, obtained with treatment processes which comprise treatment with sulphates or sulphites (sulphate or Kraft process, sulphite process, semi-chemical process), and sulphur-free lignin, obtained with treatment processes which comprise treatment with soda (soda pulping), with high pressure steam (steam explosion) or with organic solvents (solvent pulping). The presence of sulphur in raw sulphurous lignins produces sulphur dioxide during combustion and therefore it is preferable to use lignins that do not contain sulphur in the structure.

The alkaline metal salts of sulphonated lignins have a density of approximately 1.5 g/cm³, whereas sulphur-free lignins have a density of approximately 1.3 g/cm³. The density of raw lignins is therefore much lower than the density of carbon black.

As can easily be gathered from the chemical structure of the basic components of lignin, the latter is particularly rich in hydroxyl groups (—OH), predominantly of the phenolic or alcoholic type and, to a lesser degree, of the carboxylic type, which make the lignin particularly suitable for functionalisation.

For the purposes of the present invention, lignin is functionalised by a transesterification reaction, preferably by mechano-chemical means using a basic catalyst selected from the group consisting of alkali metal hydroxides or carbonates.

The transesterification reaction is preferably carried out with an enol ester represented by the following formulas (3) and (4):

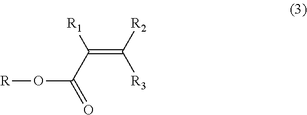

where R₁, R₂ and R₃, each independently, represents either a hydrogen atom, or a linear or branched C₁-C₆ alkyl or C₂-C₆ alkenyl group, optionally substituted by a carboxyl group (—COOH), or together they form a furan group substituted by a carboxyl group (—COOH),

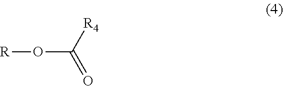

where R₄ represents a C₁-C₁₀ alkyl, C₇-C₁₅ alkylaryl, C₄-C₁₂ alkylcycloalkyl, or C₂-C₁₀ alkenyl group, linear or branched, substituted by or comprising a polysulfide —(S)ₙ—, where n is an integer from 2 to 4, and optionally substituted by a carboxyl group (—COOH), a hydroxy group (—OH), or a C₁-C₃ alkoxy group, and
where R—O represents an enol residue.

In transesterification reactions, the hydroxyl groups of lignin react with the enol ester represented by formulas (3) and (4), which acts as an acyl donor, freeing the corresponding enol and binding the acyl group, according to the following schemes (1) and (2):

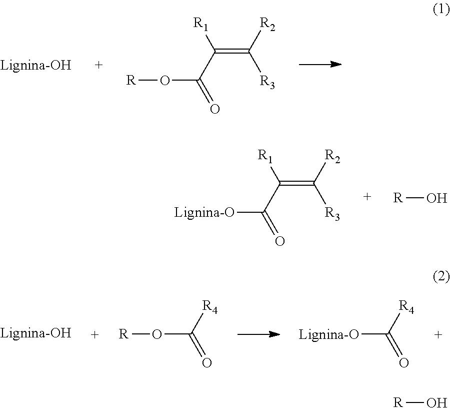

The reaction is preferably carried out in a mechanical mill which favours the mixing of the reagents and an effective reaction yield both through a partial depolymerisation of the lignin, making the hydroxyl groups of the lignin more accessible and promoting their interaction with the catalyst and the acyl donor, and through the formation of more reactive species (radicals or ions) due to the mechanical breaking of bonds.

The mechanical mill may be selected from ball mills, hammer mills, blade mills, roller mills, high pressure compression mills, ring mills, vibrating rod or tube mills, centrifugal fluid mills. Preferably, the reaction is carried out in a ball mill.

There are no particular limitations to the type of enol used to form the enol ester represented by formulas (3) and (4) described above. Preferred enols are those represented by the following formula (I):

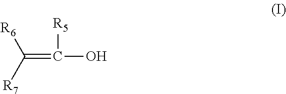

where R₅, R₆ and R₇ each independently represents a hydrogen atom, an alkyl group with 1-3 carbon atoms, or two of them together form a 5- or 6-atom carbon cycle.

Specific examples of enols are for example vinyl alcohol or ethanol and propen-2-ol.

Specific examples of enol esters used in scheme (1) described above are vinyl acrylate (VA), vinyl methacrylate (VMA), isopropenyl acrylate (or 1-methylvinyl acrylate) and isopropenyl methacrylate (or 1-methylvinyl methacrylate), and vinyl esters of the following dicarboxylic acids:

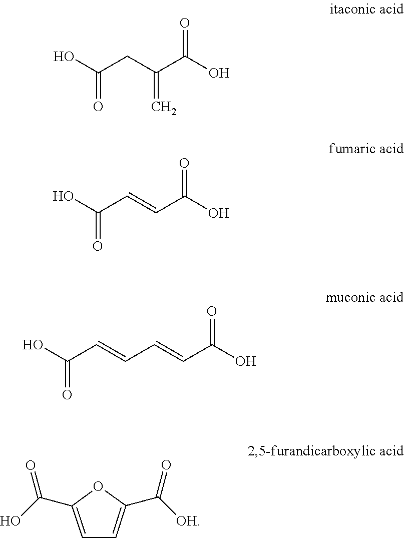

Specific examples of enol esters used in scheme (2) described above are the vinyl esters of the following compounds:

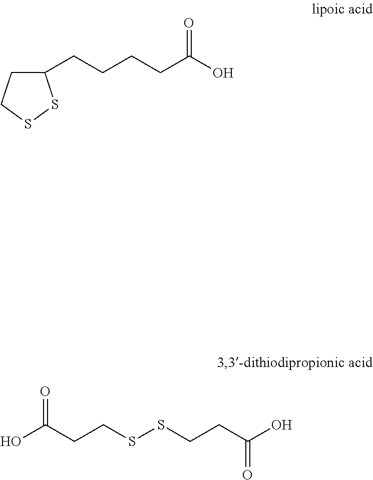 [SMILES: O=C(O)CCCCC1CCSS1 ; O=C(O)CCSSCCC(=O)O]

The starting lignin may be any type of lignin. Preferably, the lignin is selected from the group comprising Softwood Kraft lignin, Hardwood Kraft lignin, Soda Grass lignin, Wheat Straw lignin, Rice Husk lignin, lignin obtained through biorefinery processes, Organosolv lignin. Sulphur-free lignins obtained with the process described in WO2011/007369 and commercial sulphur-free lignins such as Protobind® lignins marketed by the company GreenValue SA, Switzerland and experimental lignins produced by means of the steam explosion process by Chemtex Italia Srl company, Italy may be used.

The reaction is carried out in the presence of a basic catalyst, in particular a hydroxide or carbonate of an alkali metal, such as for example, sodium hydroxide, sodium carbonate, potassium hydroxide and potassium carbonate.

Advantageously, the lignin is pretreated in the mechanical mill with the basic catalyst for a period of at least 10 minutes, preferably at least 15 minutes, more preferably for a period of between 20 and 60 minutes, at at least 100 revolutions per minute, preferably at least 200 revolutions per minute, more preferably between 200 and 600 revolutions per minute, so as to favour the uniform distribution of the catalyst and the accessibility of the hydroxyl groups.

Subsequently, the enol ester represented by the formulas (3) and (4) described above is added and the reaction is carried out for at least 1 hour, preferably at least 2 hours, more preferably for a period between 3 and 6 hours, always mixing at at least 100 revolutions per minute, preferably at least 200 revolutions per minute, more preferably between 200 and 600 revolutions per minute.

The reaction may be carried out at a temperature of between 20° C. and 80° C., preferably between 20° C. and 60° C. Advantageously, the reaction is carried out at room temperature, i.e. approximately 20° C.-25° C.

The reaction product, lignin functionalised with an acyl group represented by the formulas (1) and (2) described above, is recovered with water, preferably distilled or deionised water, precipitated by acidification of the resulting solution with strong mineral acids, such as hydrochloric acid or nitric acid, and subsequently washed and centrifuged one or more times to isolate the purified product.

Preferably, the functionalised lignin used for the purposes of the present invention has a degree of functionalisation equal to or greater than 15%, preferably equal to or greater than 20%, and more preferably between 30% and 50%.

The expression “degree of functionalisation” used in the present description and in the following claims means the percentage ratio between the millimoles of hydroxyl groups functionalised with an acyl group represented by the formulas (1) and (2) described above (per gram of functionalised lignin) and the millimoles of hydroxyl groups present in one gram of the starting lignin.

### The Predispersion of Dienic Elastomeric Polymer and Functionalised Lignin

Preferably, the diene elastomeric polymer of the predispersion used in the present invention is any diene elastomeric polymer as described below in the present description.

More preferably, the diene elastomeric polymer is selected from natural (NR) or synthetic (IR) isoprene rubber, emulsion polymerisation styrene-butadiene rubber (ESBR), carboxylated emulsion polymerisation styrene-butadiene rubber (XSBR), nitrile rubber (NBR), carboxylated nitrile rubber (XNBR), chloroprene rubber (CR), butyl rubber (IIR).

Advantageously, the diene elastomeric polymer is selected from natural (NR) or synthetic (IR) isoprene rubber.

Preferably, the predispersion of diene elastomeric polymer and functionalised lignin comprises an amount of lignin equal to or greater than 50 phr, preferably equal to or greater than 75 phr, even more preferably equal to or greater than 100 phr up to a maximum value of 160 phr.

According to a preferred embodiment, the predispersion of diene elastomeric polymer and functionalised lignin is added to the elastomeric composition in an amount such as to provide the elastomeric composition itself from 100 to 20 phr of diene elastomeric polymer, advantageously from 100 to 25 phr of diene elastomeric polymer, the balance to 100 phr being provided by the separately added diene elastomeric polymer.

According to the invention at least 20 phr, preferably at least 25 phr, more preferably at least 30 phr, and even more preferably at least 35 phr of the diene elastomeric polymer of the elastomeric composition consists of natural or synthetic isoprene rubber, preferably natural.

According to a preferred embodiment, the predispersion of diene elastomeric polymer and functionalised lignin is added to the elastomeric composition in such an amount as to provide the elastomeric composition itself with at least 10 phr of functionalised lignin, preferably at least 15 phr of functionalised lignin, more preferably at least 20 phr of functionalised lignin.

According to a preferred embodiment, the predispersion of diene elastomeric polymer and functionalised lignin is added to the elastomeric composition in such an amount as to provide the elastomeric composition itself with less than 100 phr of functionalised lignin, preferably less than 80 phr of functionalised lignin, more preferably less than 70 phr of functionalised lignin.

Preferably, the predispersion of diene elastomeric polymer and functionalised lignin is added to the elastomeric composition in such an amount as to provide the elastomeric composition with from 20 phr to 60 phr of functionalised lignin, more preferably from 25 phr to 50 phr of functionalised lignin.

Preferably, the predispersion of diene elastomeric polymer and functionalised lignin is prepared according to the process described in WO2017/109672 or WO2022/144759.

In particular, in an embodiment as described in WO2017/109672, the predispersion of diene elastomeric polymer and functionalised lignin is obtained with a process comprising:
(a) adding the functionalised lignin to a natural rubber latex,
(b) causing the co-precipitation (coagulation) of the predispersion of natural rubber and functionalised lignin from the mixture resulting from step (a), and
(c) separating the predispersion of natural rubber and functionalised lignin obtained from step (b) from a residual supernatant.

Preferably, the functionalised lignin is solubilised in an alkaline solution before being added to the natural rubber latex.

In particular, the alkaline solution comprises an aqueous solution of a base, preferably selected from the group comprising hydroxides of alkali metals, such as, for example, sodium hydroxide (NaOH) or potassium hydroxide (KOH), and ammonia (NH₃), in concentration between 0.01M and 1M, preferably between 0.1M and 0.5M. The basic conditions of the solution ensure deprotonation of the functionalised lignin acid groups (phenols and carboxylic acids), and the negative charges make the functionalised lignin macromolecules soluble and stable in aqueous solution. The addition of the functionalised lignin to the basic solution is preferably carried out under stirring and at room temperature until complete solubilisation.

The addition of the functionalised lignin to the latex is preferably carried out slowly and under stirring, and at room temperature, in a variable time, preferably between 5 and 15 minutes, and the resulting mixture is left under stirring at room temperature for a variable time, preferably between 1 and 2 hours.

Co-precipitation (coagulation) from the resulting mixture occurs by adding an acid solution.

In particular, the acid solution comprises an aqueous solution of an acid, preferably selected from the group comprising inorganic acids, such as for example hydrochloric or sulphuric acid, and organic acids, such as for example acetic acid, in a concentration comprised between 0.1M and 2M, preferably between 0.5M and 1.5M.

Advantageously, in another embodiment as described in WO2022/144759, the predispersion of diene elastomeric polymer and functionalised lignin is obtained with a process comprising:
a) preparing a first suspension of functionalised lignin in a dispersing liquid;
b) preparing a second suspension comprising functionalised lignin and diene elastomeric polymer latex by mixing the first functionalised lignin suspension obtained from step a) with said latex; and
c) removing the dispersing liquid from said second suspension comprising functionalised lignin and diene elastomeric polymer latex until said predispersion of diene elastomeric polymer and functionalised lignin is obtained.

In a particularly preferred embodiment, step a) of preparing said first suspension of functionalised lignin comprises adding to such suspension a dosed amount of at least one surfactant.

Preferably, the surfactant is an anionic surfactant, such as sodium lauryl sulphate (SLS), lauryl ethoxy sulphate (LES), alkyl-benzene-sulphonic acids (ABS) and salts thereof. More preferably, the surfactant is sodium dodecylbenzenesulphonate, a widely available low cost anionic surfactant.

Preferably, step a) of preparing the first suspension of functionalised lignin comprises adding to the first suspension of functionalised lignin an amount of surfactant comprised between 0.1 and 60 parts by weight, preferably between 1 and 10 parts by weight, per 100 parts by weight of total suspension.

Preferably, the first suspension of functionalised lignin has a solid residue comprised between 20% and 80% by weight, preferably between 30% and 70% by weight, with respect to the overall weight of the suspension.

Preferably, the first functionalised lignin suspension obtained from step a) has a % by weight of particles having a size greater than 10 microns equal to or less than 10% by weight, more preferably, equal to or less than 2% by weight.

Preferably, the diene elastomeric polymer latex has a solid residue of between 10% and 80% by weight, more preferably between 50% and 70% by weight, with respect to the total weight of the latex.

Preferably, the diene elastomeric polymer latex is stabilised with a weak base, for example ammonia.

Preferably, step b) of preparing the second suspension comprising functionalised lignin and diene elastomeric polymer latex is carried out by mixing from 30 to 200 parts by weight, preferably from 60 to 140 parts by weight, of the first functionalised lignin suspension obtained from step a) to 100 parts by weight of diene elastomeric polymer latex.

In a particularly preferred embodiment, step b) of preparing the second suspension comprising functionalised lignin and diene elastomeric polymer latex is carried out by mixing the first functionalised lignin suspension obtained from step a) with said latex for a time such as to obtain a substantially homogeneous second suspension.

Preferably, the mixing time is between 5 minutes and 120 minutes.

In a preferred embodiment, the mixing contemplated in step b) is carried out by means of a batch mixer with mechanical stirrer.

Preferably, step c) of removing the dispersing liquid from the second suspension comprising functionalised lignin and diene elastomeric polymer latex comprises d) drying the second suspension.

Preferably, step d) of drying the second suspension comprising functionalised lignin and diene elastomeric polymer latex is carried out until a moisture content of the predispersion of diene elastomeric polymer and functionalised lignin is brought to a value equal to or less than 5% by weight, preferably equal to or less than 2% by weight.

Preferably, step d) of drying the second suspension comprising functionalised lignin and diene elastomeric polymer latex is carried out in a static oven at a temperature of between 40 and 120° C., for example 60° C., for a time between 2 and 30 hours.

In an alternative embodiment, step c) of removing the dispersing liquid from the second suspension comprising functionalised lignin and diene elastomeric polymer latex may comprise a step e) of removing part of the dispersing liquid, for example by filtration or centrifugation or decantation, before drying said second suspension.

In a preferred embodiment, the process of preparing the predispersion of diene elastomeric polymer and functionalised lignin may comprise a step f) of compacting the predispersion of diene elastomeric polymer and functionalised lignin obtained from step c).

Advantageously, this compacting step may be carried out by means of apparatuses normally used in the rubber field, such as, for example, an open roller mixer (open mill) or an internal mixer.

In this way, it is possible to obtain a semi-finished product in the form of a sheet which may be subsequently used in the operations for the production of the vulcanisable elastomeric composition which will be better described below.

Alternatively, the predispersion of diene elastomeric polymer and functionalised lignin may be used in the form of bales as conventionally occurs in the case of compositions based on elastomeric polymer.

### Diene Elastomeric Polymer

The diene elastomeric polymer that is used in the present invention may be selected from those commonly used in sulphur-cross-linkable elastomeric materials, which are particularly suitable for producing tyres, i.e. from elastomeric polymers or copolymers with an unsaturated chain characterised by a glass transition temperature (Tg) generally lower than 20° C., preferably in the range of from 0° C. to −110° C. These polymers or copolymers may be of natural origin or may be obtained by solution polymerisation, emulsion polymerisation or gas-phase polymerisation of one or more conjugated diolefins, optionally mixed with at least one comonomer selected from monovinylarenes and/or polar comonomers.

The conjugated diolefins generally contain from 4 to 12, preferably from 4 to 8 carbon atoms and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene or mixtures thereof. 1,3-butadiene and isoprene are particularly preferred.

Monovinylarenes, which may optionally be used as comonomers, generally contain from 8 to 20, preferably from 8 to 12 carbon atoms and may be selected, for example, from: styrene; 1-vinylnaphthalene; 2-vinylnaphthalene; various alkyl, cycloalkyl, aryl, alkylaryl or arylalkyl derivatives of styrene, such as, for example, α-methylstyrene, 3-methylstyrene, 4-propylstyrene, 4-cyclohexylstyrene, 4-dodecylstyrene, 2-ethyl-4-benzylstyrene, 4-p-tolyl-styrene, 4-(4-phenylbutyl) styrene, or mixtures thereof. Styrene is particularly preferred.

Polar comonomers that may optionally be used, can be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile or mixtures thereof.

Preferably, the diene elastomeric polymer which can be used in the present invention can be selected, for example, from: cis-1,4-polyisoprene (natural or synthetic, preferably natural rubber), 3,4-polyisoprene, polybutadiene (in particular polybutadiene with a high content of 1,4-cis), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

A diene elastomeric polymer functionalised by reaction with suitable terminating agents or coupling agents may also be used. In particular, the diene elastomeric polymers obtained by anionic polymerisation in the presence of an organometallic initiator (in particular, an organolithium initiator) may be functionalised by reacting the residual organometallic groups derived from the initiator with suitable terminating agents or coupling agents such as, for example, imines, carbodiimides, alkyltin halides, substituted benzophenones, alkoxysilanes or aryloxysilanes.

### Reinforcing Filler

The reinforcing filler used in the tyre according to the present invention comprises carbon black and/or a white filler.

According to a preferred embodiment, the carbon black reinforcing filler which may be used in the present invention may be selected from those having a surface area of not less than 20 m²/g (as determined by STSA-Statistical Thickness Surface Area-according to ISO 18852:2005).

The white filler is preferably selected from conventional silica and silicates, in the form of fibres, flakes or granules, such as bentonite, nontronite, beidellite, volkonskoite, hectorite, saponite, sauconite, vermiculite, sericite, sepiolite, paligorskite also known as attapulgite, montmorillonite, alloisite and the like, optionally modified by acid treatment and/or derivatised, and mixtures thereof, more preferably it is silica.

Silica may vary in shape, specific surface area and size.

Examples of silica are a pyrogenic silica, a precipitated amorphous silica, a wet silica (hydrated silicic acid), or mixtures thereof.

Examples of suitable commercial silicas are the precipitated silica Rhodia Zeosil MP1165 (BET specific surface area 160 m²/g), Ultrasil VN3 GR (BET specific surface area 180 m²/g) and Zeosil 1115 MP (BET specific surface area 95-120 m²/g).

Preferably, the silica has a specific surface area (BET) of at least 120 m²/g, more preferably of at least 140 m²/g.

Preferably, the silica has a specific surface area (BET) smaller than 220 m²/g, more preferably smaller than or equal to 180 m²/g.

According to a preferred embodiment, the reinforcing filler is present in the elastomeric composition in an amount greater than about 15 phr, preferably greater than about 20 phr. Preferably, the carbon black reinforcing filler is present in the elastomeric composition in an amount of less than about 45 phr, preferably less than about 40 phr.

### Vulcanising Agent

The elastomeric composition may be vulcanised according to known techniques, in particular with sulphur-based and/or peroxide-based vulcanising systems commonly used for diene elastomeric polymers.

To this end, in the elastomeric compound obtained from the elastomeric composition after one or more thermomechanical treatment steps, a sulphur-based or peroxide-based vulcanising agent is incorporated together with vulcanisation accelerants.

Specific examples of peroxides are organic peroxides, such as dicumyl peroxide (DCP), 2,5-dimethyl-2,5-di(tert-butylperoxy) hexane (DBPH), bis-(2,4-dichlorobenzoyl) peroxide (DCBP), di-tert-butyl peroxide.

In the final treatment step, the temperature is generally kept below 120° C. and preferably below 100° C., so as to prevent any undesired pre-cross-linking phenomena.

Preferably, said vulcanising agent comprises sulphur-based vulcanising systems comprising sulphur or sulphur-containing molecules (sulphur donors) together with vulcanisation accelerants and/or activators known in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, or mixture thereof.

The accelerants which are commonly used may be selected from: dithiocarbamates, guanidine, thiourea, thiazoles, sulphenamides, thiurams, amines, xanthates or mixtures thereof.

According to a preferred embodiment, said cross-linkable elastomeric composition comprises an amount of vulcanising agent equal to or greater than about 1 phr, preferably equal to or greater than about 2 phr.

Preferably, the amount of vulcanising agent is less than or equal to about 7.5 phr, preferably less than or equal to about 7.

Advantageously, the amount of sulphur is between about 2 phr and about 6.5 phr.

### Other Additives

According to an embodiment, the elastomeric composition may comprise a silane coupling agent able to interact with the silica optionally present as reinforcing filler and/or the silicates and to bind it to the diene elastomeric polymer during the vulcanisation.

According to an embodiment, the silane coupling agent which may be used in the present invention may be selected from those having at least one hydrolysable silane group, which may be identified, for example, by the following general formula (II):

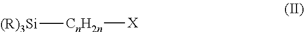

where the R groups, which may be the same or different, are selected from: alkyl, alkoxy or aryloxy groups or from halogen atoms, provided that at least one of the R groups is an alkoxy or aryloxy group; n is an integer of between 1 and 6, inclusive; X is a group selected from: nitrous, mercapto, amino, epoxide, vinyl, imide, chlorine, —(S)ₘCₙH₂ₙ—Si—(R)₃ and —S—COR, where m and n are integers of between 1 and 6 inclusive and the R groups are as defined above.

Among the silane coupling agents, bis(3-triethoxysilylpropyl)tetrasulphide and bis(3-triethoxysilylpropyl)disulphide are particularly preferred. Said coupling agents may be used as such or as a suitable mixture with an inert filler (such as carbon black) so as to facilitate their incorporation into the elastomeric composition.

According to an embodiment, said silane coupling agent may be present in the elastomeric composition in an amount ranging between 0.01 phr and about 10 phr, preferably between about 0.5 phr and about 5 phr.

Said elastomeric composition may comprise other commonly used additives, selected on the basis of the specific application for which the composition is intended. For example, said materials may be admixed with: antioxidants, anti-ageing agents, plasticisers, adhesives, anti-ozone agents, modifying resins, or mixtures thereof.

In particular, in order to improve the processability, said vulcanisable elastomeric composition may be admixed with a plasticiser generally selected from mineral oils, vegetable oils, synthetic oils or mixtures thereof, such as, for example, aromatic oil, naphthenic oil, phthalates, soybean oil or mixtures thereof. The amount of plasticiser generally ranges from 0 phr and about 70 phr, preferably from about 5 phr to about 30 phr.

### Preparation of the Elastomeric Composition

The elastomeric composition may be prepared by mixing the necessary amount of diene elastomeric polymer with the predispersion of diene elastomeric polymer and functionalised lignin, the reinforcing filler, the vulcanising agent and any other additives optionally present according to the techniques known in the industry.

According to the invention at least 20 phr, preferably at least 25 phr, more preferably at least 30 phr, and even more preferably at least 35 phr of the diene elastomeric polymer of the elastomeric composition consists of natural or synthetic isoprene rubber, preferably natural.

The mixing may be carried out, for example, using at least one batch mixer and/or at least one continuous mixer.

The predispersion of a diene elastomeric polymer and functionalised lignin may be fed to said at least one batch mixer and/or at least one continuous mixer according to any method known to those skilled in the art and suitable for the purpose.

For example, the predispersion may be fed in the form of material in bales or sheets obtained as described above in the process for preparing the predispersion.

In the context of the present description and the subsequent claims, the term “batch mixer (or mixing device)” indicates a mixing device configured to be periodically fed with the various ingredients of the material to be prepared in predefined amounts and for mixing them for a predetermined time in order to obtain a batch of said material.

At the end of the mixing step, the entire batch of material obtained is completely discharged from the mixing device in a single solution. Examples of batch mixers are internal mixers of the type with tangential rotors (Banbury®) or with interpenetrating rotors (Intermix®).

In the context of the present description and of the subsequent claims, the term “continuous mixer (or mixing device)” indicates a mixing device configured to continuously feed the ingredients of the material to be prepared, typically by means of controlled dosage dispensers, to mix the ingredients in order to produce the material and to discharge it in a continuous flow (except possible stoppages of the mixing device due to maintenance, or change of the recipe of the material).

In the jargon of the elastomeric mixers sector, the continuous mixing device is sometimes referred to as: “mixing extruder”, which is herein considered equivalent to a “continuous mixer”.

The continuous mixer (in particular its active elements, such as screws or mixer satellites) is then provided with mixing portions able to impart a high shear stress to the material being mixed and, alternating with the mixing portions, transport portions able to impart a thrust to the material being processed to feed it from one longitudinal end to the other of the internal chamber. It may further be provided with possible redistribution portions.

Examples of continuous mixing devices are twin-screw or multi-screw mixers (e.g. ring mixers), co-penetrating and co-rotating, or planetary mixing devices.

Both the batch mixer and the continuous mixer are able to impart to the material to be produced with them sufficient energy to mix and homogeneously disperse the various components even in the case of cold feeding of the ingredients and, in the case of a material comprising an elastomeric component, to chew the elastomeric compound raising the temperature thereof so as to make it workable and plastic to facilitate the incorporation and/or distribution of the ingredients within the elastomeric polymeric matrix.

The elastomeric compound thus obtained may then be stored or sent directly to the subsequent production steps of the tyre according to the present invention.

### The Tyre

According to an embodiment, the tyre for vehicle wheels according to the invention comprises
a carcass structure comprising at least a carcass ply having opposite lateral edges associated to respective bead structures;
optionally a belt structure applied in radially external position with respect to the carcass structure;
a tread band applied in a radially external position to said carcass structure and to said belt structure, if present, and
optionally, an underlayer and/or an anti-abrasive elongate member and/or a pair of sidewalls and/or a sidewall insert and/or a mini-sidewall and/or an underliner and/or a rubberising layer and/or flipper and/or chafer and/or a bead filler and/or a sheet.

According to one embodiment, the structural element according to the invention is selected from the group consisting of carcass structure, belt structure, tread band and pair of sidewalls.

The tyre according to the invention may be used on two, three or four-wheeled vehicles. The tyre according to the invention may be for summer or winter use or for all seasons.

The tyre according to the invention may be a tyre for passenger cars, including both automobile tyres, such as for example the high-performance tyres, and tyres for light transport vehicles, for example vans, campers, pick-up, typically with total mass at full load equal to or less than 3500 kg. Therefore, tyres for heavy transport vehicles are excluded.

The tyre according to the invention may be a tyre for motorcycles, such as for example motorcycles belonging to the scooter, road enduro, custom, hypersport, supersport, and sport touring categories. The term “tyre for motorcycle wheels” means a tyre having a high curvature ratio (typically greater than 0.200), capable of reaching high angles of inclination (roll angles) during cornering of the motorcycle.

### DRAWINGS

The description is given hereinafter with reference to the accompanying drawings, provided only for illustrative and, therefore, non-limiting purposes, in which:

FIG. 1 schematically shows a semi-sectional view of a tyre for vehicle wheels according to the present invention,

FIG. 2 illustrates the FT-IR/ATR graph obtained with the lignin of the comparison procedure COMP1 (Curve A) superimposed on the graph obtained with the starting lignin (Curve B) as described in Example 1,

FIG. 3 illustrates the FT-IR/ATR graph obtained with the lignin of the procedures of the invention INV2 (Curve A) and INV3 (Curve B) superimposed on the graph obtained with the starting lignin (Curve C) as described in Example 1,

FIG. 4 illustrates the FT-IR/ATR graph obtained with the lignin of the comparison procedure COMP4 (Curve A) superimposed on the graph obtained with the starting lignin (Curve B) as described in Example 1.

### DETAILED DESCRIPTION OF THE INVENTION

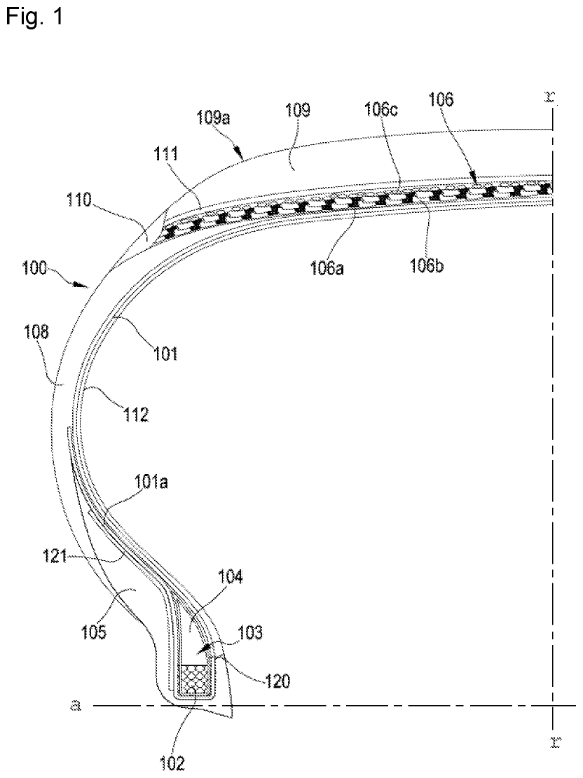

The present invention will be illustrated in further detail by means of an illustrative embodiment with reference to the accompanying FIG. 1, where “a” indicates an axial direction and “r” indicates a radial direction. For simplicity, FIG. 1 shows only a part of the tyre, the remaining part not shown being identical and disposed symmetrically with respect to the radial direction “r”.

The reference numeral 100 indicates in FIG. 1 a tyre for vehicle wheels, which generally comprises a carcass structure 101 having respectively opposite end flaps engaged with respective annular anchoring structures 102, called bead cores, optionally associated with a bead filler 104. The tyre area comprising the bead core 102 and the filler 104 forms a bead structure 103 intended for anchoring the tyre onto a corresponding mounting rim, not shown. Each bead structure 103 is associated to the carcass structure by folding back of the opposite lateral edges of the at least one carcass layer 101 around the bead core 102 so as to form the so-called carcass flaps 101a as shown in FIG. 1.

The carcass structure 101 is optionally associated with a belt structure 106 comprising one or more belt layers 106a, 106b placed in radial superposition with respect to one another and with respect to the carcass structure 101, having typically metal reinforcing cords. Such reinforcing cords may have crossed orientation with respect to a circumferential extension direction of the tyre 100. By “circumferential” direction we mean a direction generally facing according to the direction of rotation of the tyre, or in any case slightly inclined with respect to the direction of rotation of the tyre.

The belt structure 106 further comprises at least one radially external reinforcing layer 106c with respect to the belt layers 106a, 106b. The radially external reinforcing layer 106c comprises textile or metal cords, disposed according to a substantially zero angle with respect to the circumferential extension direction of the tyre and immersed in the elastomeric material. Preferably, the cords are disposed substantially parallel and side by side to form a plurality of turns. Such turns are substantially oriented according to the circumferential direction (typically with an angle of between 0° and) 5°, such direction being usually called “zero degrees” with reference to the laying thereof with respect to the equatorial plane r-r of the tyre. By “equatorial plane” of the tyre it is meant a plane perpendicular to the axis of rotation of the tyre and which divides the tyre into two symmetrically equal parts.

A tread band 109 of a vulcanised elastomeric compound is applied in a radially internal position with respect to the carcass structure 101 and/or if present (as in the illustrated case) to the belt structure 106.

In a radially external position, the tread band 109 has a rolling portion 109a intended to come into contact with the ground. Circumferential grooves, which are connected by transverse notches (not shown in FIG. 1) so as to define a plurality of blocks of various shapes and sizes distributed in the rolling portion 109a, are generally made in this portion 109a, which for simplicity is represented smooth in FIG. 1.

To optimise the performance of the tread, the tread band may be made in a two-layer structure.

Such two-layer structure comprises the rolling layer or portion 109a (called cap) and a substrate 111 (called base) forming the so-called cap-and-base structure.

Both the tread band 109 and the cap-and-base structure formed by the rolling layer 109a and the underlayer 109 may advantageously be made with the elastomeric composition comprising the predispersion of dienic elastomeric polymer and functionalised lignin described above, since a lower hysteresis means (i) a lower dissipation of energy in the form of heat while driving, and (ii) a lower fuel consumption, and at the same time a greater resistance to tearing means a greater resistance to mechanical stresses deriving from the rolling or sliding of the tyre during use, resulting in longer tyre life.

On the lateral surfaces of the carcass structure 101, respective sidewalls 108 of vulcanised elastomeric compound are further applied in an axially external position to said carcass structure 101, each extending from one of the lateral edges of the tread band 109 up to the respective bead structure 103.

A strip consisting of elastomeric compound 110, commonly known as “mini-sidewall”, of vulcanised elastomeric compound may optionally be provided in the connecting zone between sidewalls 108 and the tread band 109, this mini-sidewall generally being obtained by co-extrusion with the tread band 109 and allowing an improvement of the mechanical interaction between the tread band 109 and the sidewalls 108. Preferably, the end portion of sidewall 108 directly covers the lateral edge of the tread band 109.

In some specific embodiments, such as the one illustrated and described herein, the stiffness of the bead 103 may be improved by providing a reinforcing layer 120 generally known as a “flipper” in the tyre bead.

The flipper 120 is wrapped around the respective bead core 102 and the bead filler 104 so as to at least partially surround them. The flipper 120 is disposed between the carcass layer 101 and the bead structure 103. Usually, the flipper 120 is in contact with the carcass layer 101 and said bead structure 103. The flipper 120 typically comprises a plurality of metal or textile cords incorporated in a vulcanised elastomeric compound.

In some specific embodiments, such as the one illustrated and described herein, the bead structure 103 may further comprise a further reinforcing layer 121 which is generally known by the term of “chafer” and which has the function to increase the rigidity and integrity of the bead structure 103.

The chafer 121 usually comprises a plurality of cords incorporated in a vulcanised elastomeric compound; such cords are generally made of textile material (for example aramid or rayon), or of metallic material (for example steel cords).

Optionally, an anti-abrasive strip 105 is disposed so as to wrap the bead structure 103 along the axially internal and external and radially internal areas of the bead structure 103, thus interposing itself between the latter and the wheel rim when the tyre 100 is mounted on the rim.

Moreover, a radially internal surface of tyre 100 is preferably internally lined by a layer of substantially airtight elastomeric material, or so-called liner 112.

According to an embodiment not shown, the tyre may be a tyre for motorcycle wheels. The profile of the straight section of the tyre for motorcycle (not shown) has a high transversal curvature since it must guarantee a sufficient footprint area in all the inclination conditions of the motorcycle. The transverse curvature is defined by the value of the ratio between the distance f of the ridge of the tread from the line passing through the laterally opposite ends of the tread itself, measured on the equatorial plane of the tyre, and the width C defined by the distance between the laterally opposite ends of the tread itself. A tyre with high transverse curvature indicates a tyre whose transverse curvature ratio (f/C) is at least 0.20.

The reinforcing elements of the belt structure 106, and/or of the carcass structure 101, and/or of the bead structure 103, such as the flipper 120 and/or the chafer 121, may be advantageously made with the elastomeric composition comprising the predispersion of diene elastomeric polymer and functionalised lignin described above, since a lower hysteresis means (i) a lower dissipation of energy in the form of heat during driving, preventing the onset of operating temperatures that are too high which may risk compromising the integrity of the tyre, and at the same time greater resistance to tearing means greater resistance to the mechanical stresses suffered by the tyre during use, in particular in the area of the bead in contact with the wheel rim.

The building of the tyre 100 as described above is carried out by assembling respective semi-finished products onto a forming drum, not shown, by at least one assembly device.

At least a part of the components intended to form the carcass structure 101 of the tyre 100 is built and/or assembled on the forming drum. More particularly, the forming drum is intended to first receive the possible liner 112, and then the carcass ply 101. Thereafter, devices non shown coaxially engage one of the annular anchoring structures 102 around each of the end flaps, position an external sleeve comprising the belt structure 106 and the tread band 109 in a coaxially centred position around the cylindrical carcass sleeve and shape the carcass sleeve according to a toroidal configuration through a radial expansion of the carcass ply 101, so as to cause the application thereof against a radially internal surface of the external sleeve.

After building of the green tyre 100, a moulding and vulcanisation treatment is generally carried out in order to determine the structural stabilisation of the tyre 100 through vulcanisation of the elastomeric compounds, as well as to impart a desired tread pattern on the tread band 109 and to impart any distinguishing graphic signs at the sidewalls 108.

The present invention will be further illustrated below by means of a number of preparatory examples, which are provided for indicative purposes only and without any limitation of the present invention.

### Example 1

### Preparation of Functionalised Lignins

The following procedure was carried out using the amount and nature of the reagents shown in Table 1.

A sample of Softwood Kraft UPM BioPiva™ 200 lignin (UPM Biochemicals-solids content 55%) is pretreated in a ball mill with the basic catalyst for 30 minutes (400 rpm). Afterwards, the acyl donor was added and the reaction was carried out for 4 h (400 rpm).

The product was recovered with deionised water, and the resulting solution was acidified with 0.1 M HCl until the functionalised lignin precipitated (pH<3.5).

The resulting suspension was centrifuged, the supernatant was removed, and the solid residue was resuspended in deionised water, and centrifuged again to isolate the purified product.

TABLE 1

| | COMP1 | INV2 | INV3 | COMP4 |
|---|---|---|---|---|
| | procedure | procedure | procedure | procedure |
| Lignin (g) | 9.090 | 9.090 | 9.090 | 9.090 |
| Catalyst | NaOH | NaOH | Na₂CO₃ | CaCO₃ |
| Catalyst Amount (mg) | 539 | 539 | 4529 | 4529 |
| Acyl donor | MMA | VMA | VMA | VMA |
| Acyl donor volume (ml) | 0.721 | 0.721 | 0.961 | 0.961 |
| Deionised Water | 75 | 75 | 75 | 75 |
| Volume (ml) | | | | |
| HCl 0.1 M Volume (ml) | 25 | 25 | 25 | 25 |

MMA: Methyl methacrylate
VMA: Vinyl methacrylate

The lignins obtained with procedures 1-4 were evaluated by FT-IR/ATR analysis to verify the increase in the peak at 1720 cm⁻¹ attributable to the presence of the carboxyl group. An increase in such peak is an indicator of the successful functionalisation derived from the esterification of the hydroxyl groups with the carboxyl group of the acyl donor.

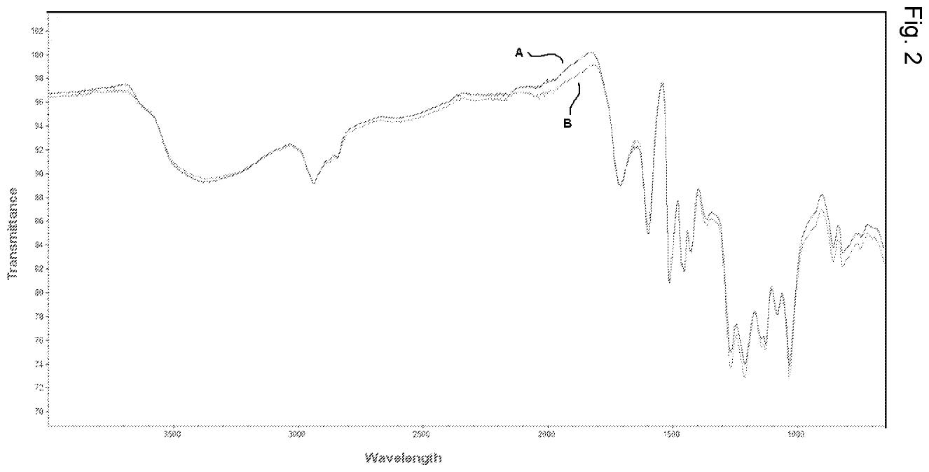

FIG. 2 illustrates the graph obtained with the lignin from the comparison procedure COMP1 (Curve A) superimposed on the graph obtained with the starting lignin (Curve B) not subjected to any functionalisation treatment. No variation in intensity of the peak at 1720 cm⁻¹, indicative of a lack of functionalisation of the lignin obtained with the comparison procedure COMP1 (NaOH catalyst-methyl methacrylate acyl donor), was observed.

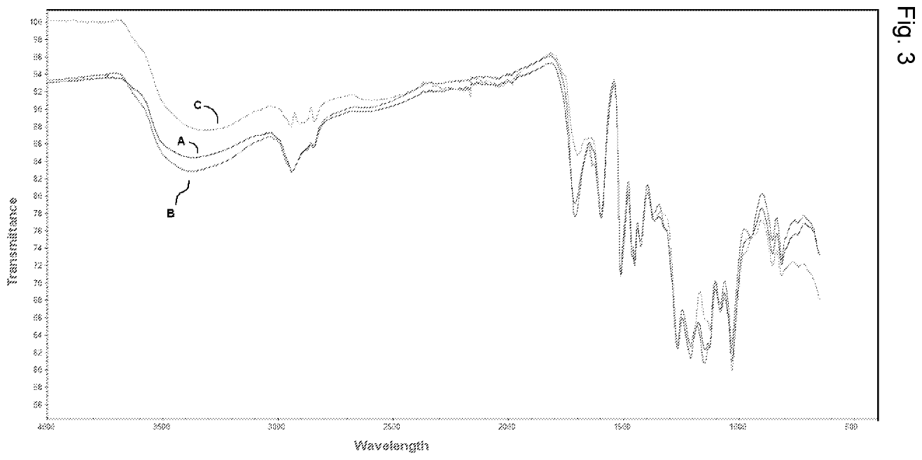

FIG. 3 illustrates the graph obtained with the lignin of the procedures of the invention INV2 (Curve A) and INV3 (Curve B) superimposed on the graph obtained with the starting lignin (Curve C) not subjected to any functionalisation treatment. A marked variation in intensity of the peak at 1720 cm⁻¹ was observed, indicative of a consistent degree of esterification of the lignin obtained with the procedure INV2 (NaOH catalyst-vinyl methacrylate acyl donor) and INV3 (Na₂CO₃ catalyst-vinyl methacrylate acyl donor).

The degree of functionalisation achieved by the lignin of the procedure of the invention INV2 was quantified via 31P-NMR analysis by difference in the areas of the peaks relating to the hydroxyl groups. The following Table 1A summarises the values obtained.

TABLE 1A

| | Starting lignin | Functionalised | Degree of |
|---|---|---|---|
| Functional group | mmol/g | lignin mmol/g | functionalisation |
| Alcoholic hydroxyl | 1.60 | 1.03 | 35% |
| Phenolic hydroxyl | 3.10 | 2.17 | 30% |
| Total hydroxyls | 4.70 | 3.20 | 32% |

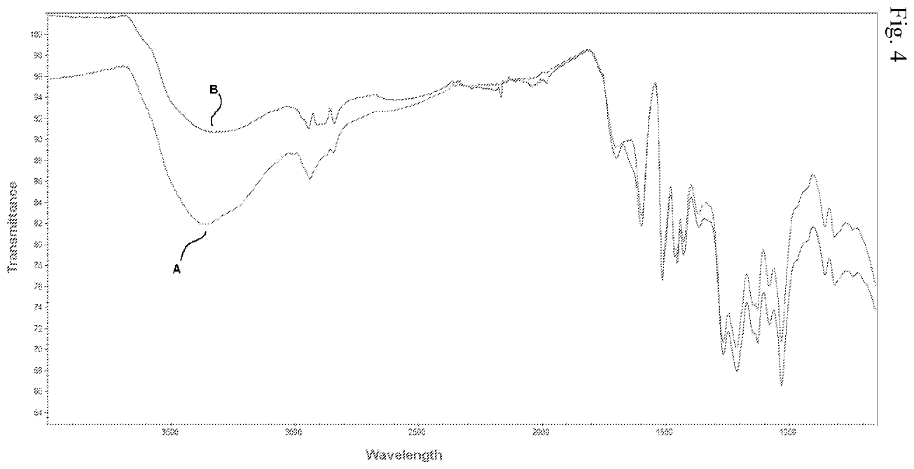

FIG. 4 illustrates the graph obtained with the lignin from the comparison procedure COMP4 (Curve A) superimposed on the graph obtained with the starting lignin (Curve B) not subjected to any functionalisation treatment. No variation in intensity of the peak at 1720 cm⁻¹, indicative of a lack of functionalisation of the lignin obtained with the comparison procedure COMP4 (CaCO₃ catalyst-acyl donor vinyl methacrylate), was observed.

### Example 2

### Preparation of Predispersions of a Diene Elastomeric Polymer and Lignin Comprising 50% w/w Lignin

The non-functionalised Kraft lignin and the functionalised lignins obtained according to the procedures of the invention INV2 and INV3 of Example 1 were used to prepare 50% predispersions of lignin and natural rubber according to a co-precipitation procedure as described in WO2017/109672, according to a co-drying procedure, as described in WO2022/144759.

In the case of the co-precipitation procedure, a 7% w/w mixture of (starting or functionalised) lignin in water was prepared and the pH was brought to 11 by adding 0.1 M NaOH. After 10 minutes of stirring, the solution was slowly poured into a 60% w/w suspension of natural rubber from HA latex obtained by centrifugation and stabilised with ammonia (Von Bundit Co. Ltd.). The suspension was kept under constant stirring for 30 minutes.

The co-precipitation procedure was performed by slowly adding a 20% w/w H₂SO₄ solution to the suspension of lignin and natural rubber latex until precipitation of the suspension was observed. The precipitate was filtered on a Buchner filter and washed with deionised water until a pH value of 6 was obtained in the washing water. The resulting predispersion was dried at 45° C. for 3 days.

In the case of the co-drying procedure, a 7% w/w mixture of (starting or functionalised) lignin in water was prepared and the pH was brought to 10.5-11 by adding a 33% aqueous solution of NH₄OH. After 10 minutes of stirring, the solution was slowly poured into a 60% w/w suspension of natural rubber from HA latex obtained by centrifugation and stabilised with ammonia (Von Bundit Co. Ltd.). The suspension was kept under constant stirring for 30 minutes.

The co-drying procedure was performed by directly drying the lignin and natural rubber latex suspension at 45° C. for 3 days.

The following Table 2 summarises the lignin and procedure features used to make the comparison predispersions and the predispersions according to the present invention.

TABLE 2

| | Lignin | Procedure |
|---|---|---|
| MBComp1 | Not functionalised | Co-precipitation |
| MBComp2 | Not functionalised | Co-drying |
| MBInv1 | INV2 | Co-precipitation |
| MBInv2 | INV3 | Co-precipitation |
| MBInv3 | INV2 | Co-drying |
| MBInv4 | INV3 | Co-drying |

### Example 3

### Use of Predispersions MBComp1 and MBInv1 in the Preparation of an Elastomeric Compound Based on Styrene-Butadiene Rubber

The predispersions MBComp1 and MBInv1 were used to produce a comparison vulcanisable elastomeric compound (C₁) and a vulcanisable elastomeric compound of the invention (MINV1), respectively.

The following Table 3A shows the phr compositions of the vulcanisable elastomeric compounds C₁ and MINV1. The predispersions MBComp1 and MBInv1 are added in such amounts as to provide 25 phr of natural rubber and 25 phr of lignin to the compounds C₁ and MINV1.

TABLE 3A

| | C1 | MINV1 |
|---|---|---|
| SBR | 103.1 | 103.1 |
| MBComp1 | 50 | — |
| MBInv1 | — | 50 |
| Silica | 35 | 35 |
| Silane | 2.8 | 2.8 |
| 6PPD | 2 | 2 |
| Peroxide | 3 | 3 |

SBR: Styrene butadiene copolymer, extended with 37.5 parts of TDAE oil for every 100 parts of dry polymer-microstructure with 24.9% styrene and 61.7% vinyl on the butadiene fraction-SPRINTANYTY SLR 4630 from Synthos;
Silicia: Highly dispersible precipitated silica Zeosil 1165 MP from Solvay;
Silane: 2-(methacryloy)ethyl 3-(triethoxy silane)-TEMS from JH silanes;
6PPD: N-(1,3-dimethylbutyl)-N′-phenyl-p-phenylenediamine, from Flexys;
Peroxide: 2,5-dimethyl-2,5-di(tert-butylperoxyl)hexane, 45% dispersion-on calcium carbonate and silica-Luperox ® 101 XL45 from Sigma-Aldrich

All components, with the exception of the peroxide and the protective agent (6PPD), were mixed in an internal mixer (Brabender) for approximately 9 minutes (1^{st} step).

When the temperature of 135° C. was reached, the material was mixed for another minute and then discharged. The uncompleted compound was left to rest for a day, then the peroxide and the protective agent were added and mixing was carried out in the same mixer at approximately 60° C. for 9 minutes (2^{nd} step). Finally, the compound was vulcanised at 170° C. for 10 minutes, in order to be able to measure its static mechanical properties, while the dynamic mechanical properties were measured on the vulcanisable compound.

The static mechanical properties of the compounds C₁ and MINV1 were evaluated according to the ISO 37-2011 standard at 23° C., on 3 Dumbell specimens. In this way the following parameters were measured:
load at 50% elongation (Ca0.5),
load at 100% elongation (Ca1),
load at 300% elongation (Ca3),
breaking load (CR), and
% elongation at break (AR).

The dynamic mechanical properties of shear and Tan delta dynamic modulus G′ of compounds C₁ and MINV1 were evaluated using an Alpha Technologies R.P.A. 2000 oscillating chamber rheometer (Rubber Process Analyser) with chamber geometry as described in ASTM D6601-19 FIG. 1, applying the following method.

An approximately cylindrical test sample with a volume in the range from 4.6 to 5 cm³ was obtained by punching a sheet with a thickness of at least 5 mm of the green vulcanisable elastomeric composition to be characterised. Subsequently, the chambers of the R.P.A. 2000 were preliminarily preheated to 170° C.

The sample was loaded between the chambers of the rheometer and the chambers were closed. Between the sample of the green vulcanisable elastomeric composition and each chamber of the rheometer, two films were interposed to protect the chamber itself: in contact with the compound, a film of Nylon 6.6 cast about 25 microns thick and in contact with the chamber of the rheometer a polyester film about 23 microns thick. The sample was then vulcanised for a fixed time of 10 minutes at a temperature of 170° C. while recording the vulcanisation curve, i.e. subjecting the sample to a sinusoidal deformation of 7% amplitude and 1.67 Hz frequency for the entire duration of the vulcanisation.

The temperature of the rheometer chambers was then brought to 70° C. After a total time of 10 minutes since the chamber temperature was set at 70° C., a sequence of dynamic measurements is performed at a constant temperature of 70° C. by sinusoidally stressing the sample in torsion at a fixed frequency of 100 Hz and amplitude progressively increasing from 0.3% to 10%, carrying out 10 stabilisation cycles and 10 measurement cycles for each condition.

Always keeping the temperature of the rheometer chambers at 70° C., a dynamic measurement is then carried out by sinusoidally stressing the sample in torsion at the fixed frequency of 100 Hz and amplitude of 9%, carrying out 10 stabilisation cycles and 20 measurement cycles.

In this way, the following parameters were measured as an average of what was recorded in the 20 measurement cycles:
dynamic shear modulus G′,
variation of the dynamic shear modulus d_G′ between an amplitude of the sample deformation of 0.4% and one of 10%;
torsion tan delta, i.e. the ratio between the viscous elastic modulus G″ and the dynamic elastic modulus G′, at a deformation amplitude of 9% (hereinafter Tan delta (9%)).

The following Table 3B shows the results obtained from the characterisations carried out.

TABLE 3B

| | C1 | MINV1 |
|---|---|---|
| Ca0.5 MPa | 0.90 | 0.87 |
| Ca1 MPa | 1.22 | 1.22 |
| Ca3 MPa | 3.31 | 4.36 |
| CR MPa | 10.59 | 12.15 |
| AR % | 703.57 | 611.58 |
| d_G′(0.4-10) (MPa) | 0.60 | 0.67 |
| G′ (9%) (MPa) | 1.01 | 1.03 |
| Tan Delta (9%) | 0.188 | 0.183 |

The results of Table 3B demonstrated that the mixture of the invention (MINV1), including the predispersion MBInv1, exhibited a substantial improvement in the Ca3 value for the same Ca1, therefore improving the Ca3/Ca1 ratio indicative of a better interaction between the reinforcing filler and the elastomeric composition and also the breaking load value, predictive of better resistance to tearing.

### Example 4

### Use of Predispersions MBComp1 and MBInv1 in the Preparation of an Elastomeric Compound Based on Butadiene Rubber and Natural Rubber.

The predispersions MBComp1 and MBInv1 were used to produce a comparison vulcanisable elastomeric compound (C₂) and a vulcanisable elastomeric compound of the invention (MINV2), respectively.

The following Table 4A shows the phr compositions of the vulcanisable elastomeric compounds C₂ and MINV2. The predispersions MBComp1 and MBInv1 are added in such amounts as to provide 50 phr of natural rubber and 50 phr of lignin to the compounds C₂ and MINV2.

TABLE 4A

| | C2 | MINV2 |
|---|---|---|
| BR | 50 | 50 |
| MBComp1 | 100 | — |
| MBInv1 | — | 100 |
| Silica | 10 | 10 |
| Silane | 0.8 | 0.8 |
| 6PPD | 2 | 2 |
| Peroxide | 2.3 | 2.3 |

BR: High cis neodymium polybutadiene, Buna CB25 from Lanxess;
Silica: Highly dispersible precipitated silica Zeosil 1165 MP from Solvay;
Silane: 2-(methacryloyl)ethyl 3-(triethoxy silane)-TEMS from JH silanes;
6PPD: N-(1,3-dimethylbutyl)-N′-phenyl-p-phenylenediamine, from Flexys;
Peroxide: 2,5-dimethyl-2,5-di(tert-butylperoxyl)hexane, 45% dispersion on calcium carbonate and silica-Luperox ® 101XL45 from Sigma-Aldrich

All components, with the exception of the peroxide and the protective agent (6PPD), were mixed in an internal mixer (Brabender) for approximately 9 minutes (1^{st} step).

When the temperature of 135° C. was reached, the material was mixed for another minute and then discharged. The uncompleted compound was left to rest for a day, then the peroxide and the protective agent were added and mixing was carried out in the same mixer at approximately 60° C. for 9 minutes (2^{nd} step). Finally, the compound was vulcanised at 170° C. for 10 minutes, in order to be able to measure its static mechanical properties, while the dynamic mechanical properties were measured on the vulcanisable compound.

The static and dynamic mechanical properties of the compounds C₂ and MINV3 were evaluated as described in Example 3.

The following Table 4B shows the results obtained from the characterisations carried out.

TABLE 4B

| | C2 | MINV2 |
|---|---|---|
| Ca0.5 MPa | 0.89 | 0.85 |
| Ca1 MPa | 1.33 | 1.28 |
| Ca3 MPa | 5.08 | 5.44 |
| CR MPa | 9.91 | 11.08 |
| AR % | 506.29 | 508.48 |
| d_G′(0.4-10) (MPa) | 0.24 | 0.22 |
| G′ (9%) (MPa) | 1.09 | 0.77 |
| Tan Delta (9%) | 0.230 | 0.164 |

The results of Table 4B demonstrated that the mixture of the invention (INV2), including the predispersion MBInv1, exhibited a substantial improvement in the Ca3 value with substantially the same Ca1, therefore improving the Ca3/Ca1 ratio indicative of a better interaction between the reinforcing filler and the elastomeric composition and above all the breaking load value, predictive of better resistance to tearing, also exhibiting a surprising and notable reduction in hysteresis.

### Example 5

### Use of Predispersions MBComp2 and MBInv4 in the Preparation of an Elastomeric Compound Based on Styrene Butadiene Rubber

The predispersions MBComp2 and MBInv4 were used to produce a comparison vulcanisable elastomeric compound (C₃) and a vulcanisable elastomeric compound of the invention (MINV3), respectively.

The following Table 5A shows the phr compositions of the vulcanisable elastomeric compounds C₃ and MINV3. The predispersions MBComp2 and MBInv4 are added in such amounts as to provide 25 phr of natural rubber and 25 phr of lignin to the compounds C₃ and MINV3.

TABLE 5A

| | C3 | MINV3 |
|---|---|---|
| SBR | 103.1 | 103.1 |
| MBComp2 | 50 | — |
| MBInv4 | — | 50 |
| Silica | 35 | 35 |
| Silane | 2.8 | 2.8 |
| 6PPD | 2 | 2 |
| Stearic acid | 1 | 1 |
| ZnO | 1 | 1 |
| CBS | 3 | 3 |
| Sulphur | 1 | 1 |

SBR: Styrene butadiene copolymer, extended with 37.5 parts of TDAE oil for every 100 parts of dry polymer-microstructure with 24.9% styrene and 61.7% vinyl on the butadiene fraction-SPRINTAN ™ SLR 4630 from Synthos;
Silica: Highly dispersible precipitated silica Zeosil 1165 MP from Solvay;
Silane: 50% Bis(3-triethoxysilylpropyl)disulphide supported on carbon black-TESPD from JH silanes;
6PPD:N-(1,3-dimethylbutyl)-N′-phenyl-p-phenylenediamine, from Flexys;
Stearic acid: stearin from Undesa
ZnO: zinc oxide green seal, Zincol oxides
CBS: N-cyclohexylbenzothiazole-2-sulphenamide RUBENAMID C EG/Cfrom GENERAL QUIMICA.
Sulphur: Sulphur 98.50% (1% oil)-Zolfindustria

All the components, except for sulphur and the vulcanisation accelerant (CBS), were mixed in an internal mixer (Brabender) for about 9 minutes (1st step).

When the temperature of 135° C. was reached, the material was mixed for another minute and then discharged. The uncompleted compound was left to rest for a day then the sulphur and the accelerant were added and the mixing was carried out in the same mixer at about 60° C. for 9 minutes (2nd step). Finally, the compound was vulcanised at 170° C. for 10 minutes, in order to be able to measure its static mechanical properties, while the dynamic mechanical properties were measured on the vulcanisable compound.

The static and dynamic mechanical properties of the compounds C₃ and MINV2 were evaluated as described in Example 3.

The following Table 5B shows the results obtained from the characterisations carried out.

TABLE 5B

| | C3 | MINV3 |
|---|---|---|
| Ca0.5 MPa | 1.01 | 1.15 |
| Ca1 MPa | 1.41 | 1.78 |
| Ca3 MPa | 3.84 | 4.66 |
| CR MPa | 7.03 | 8.78 |
| AR % | 454.59 | 489.72 |
| d_G′(0.4-10) (MPa) | 0.44 | 0.43 |
| G′ (9%) (MPa) | 1.06 | 1.13 |
| Tan Delta (9%) | 0.121 | 0.113 |

The results of Table 5B demonstrated that the mixture of the invention (INV3), including the predispersion MBInv4, exhibited a substantial improvement in the Ca3 and breaking load value, indicative of a better interaction between the reinforcing filler and the elastomeric composition, also exhibiting a significant reduction in hysteresis.

### Example 6

### Use of Predispersions MBComp1 and MBInv1 in the Preparation of an Elastomeric Compound Based on Butadiene Rubber and Natural Rubber

The predispersions MBComp1 and MBInv1 were used to produce a comparison vulcanisable elastomeric compound (C₄) and a vulcanisable elastomeric compound of the invention (MINV4), respectively.

The following Table 6A shows the phr compositions of the vulcanisable elastomeric compounds C₄ and MINV4. The predispersions MBComp1 and MBInv1 are added in such amounts as to provide 25 phr of natural rubber and 25 phr of lignin to the compounds C₄ and MINV4.

TABLE 6A

| | C4 | MINV4 |
|---|---|---|
| BR | 50 | 50 |
| NR | 25 | 25 |
| MBComp1 | 50 | — |
| MBInv1 | — | 50 |
| CB | 25 | 25 |
| 6PPD | 2 | 2 |
| Stearic acid | 2 | 2 |
| ZnO | 3 | 3 |
| CBS | 1 | 1 |
| Sulphur | 3 | 3 |

BR: High cis neodymium polybutadiene, Buna CB25 from Lanxess;
NR: Indonesian Rubber Standard grade natural rubber, SIR20 from Aneka Bumi Pratama
CB: N550 grade carbon black from Cabot Corp;
6PPD: N-(1,3-dimethylbutyl)-N′-phenyl-p-phenylenediamine, from Flexys;
Stearic acid: stearin from Undesa
ZnO: zinc oxide green seal, Zincol oxides
CBS: N-cyclohexylbenzothiazole-2-sulphenamide RUBENAMID C EG/C from GENERAL QUIMICA.
Sulphur: 66% Oleate Insoluble Sulphur, Crystex OT 33 from Eastman

All the components, except for sulphur and the vulcanisation accelerant (CBS), were mixed in an internal mixer (Brabender) for about 9 minutes (1^{st} step).

When the temperature of 135° C. was reached, the material was mixed for another minute and then discharged. The uncompleted compound was left to rest for a day then the sulphur and the accelerant were added and the mixing was carried out in the same mixer at about 60° C. for 9 minutes (2^{nd} step). Finally, the compound was vulcanised at 170° C. for 10 minutes, in order to be able to measure its static mechanical properties, while the dynamic mechanical properties were measured on the vulcanisable compound.

The static and dynamic mechanical properties of the compounds C₄ and MINV4 were evaluated as described in Example 3.

The following Table 6B shows the results obtained from the characterisations carried out.

TABLE 6B

| | C4 | MINV4 |
|---|---|---|
| Ca0.5 MPa | 1.42 | 1.46 |
| Ca1 MPa | 2.53 | 2.65 |
| Ca3 MPa | 9.22 | 10.20 |
| CR MPa | 9.27 | 11.71 |
| AR % | 305.62 | 343.07 |
| d_G′(0.4-10) (MPa) | 0.57 | 0.59 |
| G′ (9%) (MPa) | 1.29 | 1.29 |
| Tan Delta (9%) | 0.139 | 0.141 |

The results of Table 5B demonstrated that the mixture of the invention (MINV4), including the predispersion MBInv1, exhibited a substantial improvement in the Ca3 value for the same Ca1, therefore improving the Ca3/Ca1 ratio indicative of a better interaction between the reinforcing filler and the elastomeric composition and above all the breaking load value, predictive of better resistance to tearing, given the same hysteresis values.

### Example 7

### Use of Predispersions MBComp2 and MBInv4 in the Preparation of an Elastomeric Compound Based on Butadiene Rubber and Natural Rubber

The predispersions MBComp2 and MBInv4 were used to produce a comparison vulcanisable elastomeric compound (C₅) and a vulcanisable elastomeric compound of the invention (MINV5), respectively.

The following Table 7A shows the phr compositions of the vulcanisable elastomeric compounds C₅ and MINV5. The predispersions MBComp2 and MBInv4 are added in such amounts as to provide 50 phr of natural rubber and 50 phr of lignin to the compounds C₅ and MINV5.

TABLE 7A

| | C5 | MINV5 |
|---|---|---|
| BR | 50 | 50 |
| MBComp1 | 100 | — |
| MBInv1 | — | 100 |
| CB | 25 | 25 |
| 6PPD | 2 | 2 |
| Stearic acid | 2 | 2 |
| ZnO | 3 | 3 |
| CBS | 1 | 1 |
| Sulphur | 3 | 3 |

BR: High cis neodymium polybutadiene, Buna CB25 from Lanxess;
CB: N550 grade carbon black from Cabot Corp;
6PPD: N-(1,3-dimethylbutyl)-N′-phenyl-p-phenylenediamine, from Flexys;
Stearic acid: stearin from Undesa
ZnO: zinc oxide green seal, Zincol oxides
CBS: N-cyclohexylbenzothiazole-2-sulphenamide RUBENAMID C EG/C from GENERAL QUIMICA.
Sulphur: 66% Oleate Insoluble Sulphur, Crystex OT 33 from Eastman

All the components, except for sulphur and the vulcanisation accelerant (CBS), were mixed in an internal mixer (Brabender) for about 9 minutes (1st step).

When the temperature of 135° C. was reached, the material was mixed for another minute and then discharged. The uncompleted compound was left to rest for a day then the sulphur and the accelerant were added and the mixing was carried out in the same mixer at about 60° C. for 9 minutes (2nd step). Finally, the compound was vulcanised at 170° C. for 10 minutes, in order to be able to measure its static mechanical properties, while the dynamic mechanical properties were measured on the vulcanisable compound.

The static and dynamic mechanical properties of the compounds C₅ and MINV5 were evaluated as described in Example 3.

The following Table 7B shows the results obtained from the characterisations carried out.

TABLE 7B

| | C5 | MINV5 |
|---|---|---|
| Ca0.5 MPa | 1.66 | 1.55 |
| Ca1 MPa | 2.32 | 2.26 |
| Ca3 MPa | 4.20 | 6.63 |
| CR MPa | 5.42 | 9.52 |
| AR % | 251.51 | 393.57 |
| d_G′(0.4-10) (MPa) | 0.61 | 0.92 |
| G′ (9%) (MPa) | 1.92 | 1.95 |
| Tan Delta (9%) | 0.079 | 0.094 |

The results of Table 7B demonstrated that the mixture of the invention (INV5), including the predispersion MBInv4, exhibited a surprising and significant improvement in the Ca3 value for the same Ca1, therefore improving the Ca3/Ca1 ratio indicative of a better interaction between the reinforcing filler and the elastomeric composition and above all the breaking load value, predictive of better resistance to tearing, at the expense of a slight increase in hysteresis.

1-10. (canceled)

11. A tyre for vehicle wheels which comprises at least one structural element comprising a vulcanised elastomeric compound comprising, before vulcanization, a vulcanisable elastomeric composition comprising per 100 phr of diene elastomeric polymer:
(i) a predispersion of a diene elastomeric polymer and lignin, in an amount to provide the elastomeric composition with 100 phr to 10 phr of diene elastomeric polymer an amount of lignin equal to or greater than 5 phr,
(ii) from 0 phr to 90 phr of at least one diene elastomeric polymer,
(iii) from 5 phr to 50 phr of a reinforcing filler,
(iv) from 0.1 to 12 phr of at least one vulcanising agent,
wherein the lignin is lignin functionalised with an acyl group represented by the following formulas (1) and (2): 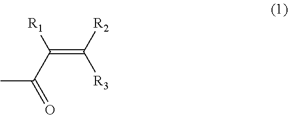
where R₁, R₂ and R₃, each independently, represents either a hydrogen atom, or a linear or branched C₁-C₆ alkyl or C₂-C₆ alkenyl group, optionally substituted by a carboxyl group (—COOH), or together forming a furan group substituted by a carboxyl group (—COOH), 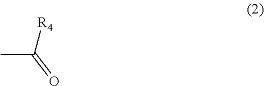
where R₄ represents a C₁-C₁₀ alkyl, C₇-C₁₅ alkylaryl, C₄-C₁₂ alkylcycloalkyl, or C₂-C₁₀ alkenyl group, linear or branched, substituted by or comprising a polysulfide —(S)ₙ—, where n is an integer from 2 to 4, and optionally substituted by a carboxyl group (—COOH), a hydroxy group (—OH), or a C₁-C₃ alkoxy group.

12. The tyre for vehicle wheels according to claim 11, wherein the pre-dispersion of diene elastomeric polymer and functionalised lignin is added to the elastomeric composition in an amount to provide the elastomeric composition with 100 phr to 20 phr of diene elastomeric polymer.

13. The tyre for vehicle wheels according to claim 11, wherein at least 20 phr of the diene elastomeric polymer of the elastomeric composition is natural or synthetic isoprene rubber.

14. The tyre for vehicle wheels according to claim 11, wherein the predispersion of diene elastomeric polymer and functionalised lignin is added to the elastomeric composition in an amount to provide the elastomeric composition with from 10 phr to 100 phr of functionalised lignin.

15. The tyre for vehicle wheels according to claim 11, wherein the predispersion of diene elastomeric polymer and functionalised lignin comprises an amount of functionalised lignin equal to or greater than 50 phr.

16. A vulcanisable elastomeric composition comprising per 100 phr of diene elastomeric polymer:
(i) a predispersion of a diene elastomeric polymer and lignin, in an amount to provide the elastomeric composition with 100 phr to 10 phr of diene elastomeric polymer an amount of lignin equal to or greater than 5 phr,
(ii) from 0 phr to 90 phr of at least one diene elastomeric polymer,
(iii) from 5 phr to 50 phr of a reinforcing filler,
(iv) from 0.1 to 12 phr of at least one vulcanising agent,
wherein the lignin is lignin functionalised with an acyl group represented by the following formulas (1) and (2): 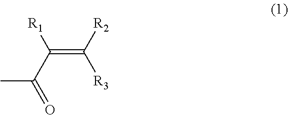
where R₁, R₂ and R₃, each independently, represents either a hydrogen atom, or a linear or branched C₁-C₆ alkyl or C₂-C₆ alkenyl group, optionally substituted by a carboxyl group (—COOH), or together forming a furan group substituted by a carboxyl group (—COOH), 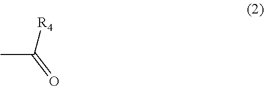
where R₄ represents a C₁-C₁₀ alkyl, C₇-C₁₅ alkylaryl, C₄-C₁₂ alkylcycloalkyl, or C₂-C₁₀ alkenyl group, linear or branched, substituted by or comprising a polysulfide —(S)ₙ—, where n is an integer from 2 to 4, and optionally substituted by a carboxyl group (—COOH), a hydroxy group (—OH), or a C₁-C₃ alkoxy group.

17. The elastomeric composition according to claim 16, wherein the pre-dispersion of diene elastomeric polymer and functionalised lignin is added to the elastomeric composition in an amount as to provide the elastomeric composition with 100 phr to 20 phr of diene elastomeric polymer.

18. The elastomeric composition according to claim 16, wherein at least 20 phr of the diene elastomeric polymer of the elastomeric composition is natural or synthetic isoprene rubber.

19. The elastomeric composition according to claim 16, wherein the predispersion of diene elastomeric polymer and functionalised lignin is added to the elastomeric composition in an amount as to provide the elastomeric composition with from 10 phr to 100 phr of functionalised lignin.

20. The elastomeric composition according to claim 16, wherein the predispersion of diene elastomeric polymer and functionalised lignin comprises an amount of functionalised lignin equal to or greater than 50 phr.

21. A process of mechano-chemical preparation of lignin functionalised with an acyl group comprising:
(a) feeding a mixing apparatus with lignin and a basic catalyst, wherein the basic catalyst is an alkali metal hydroxide or carbonate;
(b) mixing the lignin and the basic catalyst in the mixing apparatus;
(c) adding to the mixture of step (b) an acyl donor represented by an enolic ester of the acyl group, and mixing until completing the transesterification reaction; and
(d) recovering the lignin functionalised with the acyl group,
where the acyl group is represented by the following formulas (1) and (2): 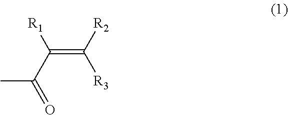
where R₁, R₂ and R₃, each independently, represents either a hydrogen atom, or a linear or branched C₁-C₆ alkyl or C₂-C₆ alkenyl group, optionally substituted by a carboxyl group (—COOH), or together they form a furan group substituted by a carboxyl group (—COOH), 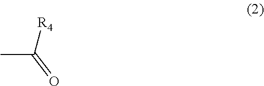
where R₄ represents a C₁-C₁₀ alkyl, C₇-C₁₅ alkylaryl, C₄-C₁₂ alkylcycloalkyl, or C₂-C₁₀ alkenyl group, linear or branched, substituted by or comprising a polysulfide —(S)ₙ—, where n is an integer from 2 to 4, and optionally substituted by a carboxyl group (—COOH), a hydroxy group (—OH), or a C₁-C₃ alkoxy group.

22. The process of mechano-chemical preparation of lignin functionalised with an acyl group according to claim 21, wherein the mixing apparatus is selected from ball mills, hammer mills, blade mills, roller mills, high-pressure compression mills, ring mills, vibrating rod or tube mills, and centrifugal fluid mills.

23. The process of mechano-chemical preparation of lignin functionalised with an acyl group according to claim 21, wherein the basic catalyst is selected from sodium hydroxide, sodium carbonate, potassium hydroxide, and potassium carbonate.

24. The process of mechano-chemical preparation of lignin functionalised with an acyl group according to claim 21, wherein the acyl donor is an ester with an enol represented by the following formula (I): 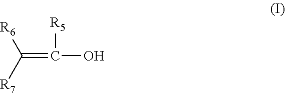
where R₅, R₆ and R₇ each independently represents a hydrogen atom, an alkyl group with 1-3 carbon atoms, or two of them together form a 5- or 6-atom carbon cycle.
